(19) United States
(12) Patent Application Publication
(10) Pub. No.: US 2008/0258583 A1
(43) Pub. Date: Oct. 23, 2008

(54) Electric Machine Comprising a Claw-Pole Stator and Claw-Pole Stator Metal Sheet

(75) Inventors: Christoph Heier, Iffezheim (DE); Bernd Hein, Baiersbronn/Schoenmuenzach (DE); Jerome Thiery, Strasbourg (FR)

Correspondence Address: MICHAEL BEST & FRIEDRICH LLP, 100 EAST WISCONSIN AVENUE, MILWAUKEE, WI, 53202, US

(73) Assignee: Robert Bosch GmbH, Stuttgart (DE)

(21) Appl. No.: 11/909,387

(22) PCT Filed: Mar. 15, 2006
(86) PCT No.: PCT/EP2006/060727

§ 371 Date: Sep. 21, 2007

(30) Foreign Application Priority Data
Apr. 26, 2005 (DE) 10 2005 019 310.2

(51) Int. Cl. H02K 29/08; H02K 1/14

(52) U.S. Cl. 310/68 B

(57) ABSTRACT

The invention relates to an electric machine comprising a rotor, a claw-pole stator (11) which surrounds the rotor, and a unit detecting the rotor position. According to the invention, a flux barrier (12) is provided in the area of a sensor (13) of the unit detecting the rotor position in order to block stray fields of the claw-pole stator (11).

### BACKGROUND OF THE INVENTION

The invention relates to an electric machine comprising a rotor and a claw-pole stator which surrounds the rotor, in which a unit detecting rotor position is provided, and a claw-pole metal sheet for an electric machine.

In the case of commutated DC motors, in particular claw-pole motors with a permanently excited rotor and an external stator with a cooper winding, the rotor position is detected by Hall sensors. The Hall sensor receives its signal to control the commutation via the changing magnetic field of the rotor. In the case of high stator currents, e.g., starting currents with high operating voltages, there is a risk that the Hall sensor will also detect stray flux of the stator and therefore generate faulty signals, which can interfere with the functioning of the electric machine.

### SUMMARY OF THE INVENTION

An electric machine comprising a rotor and a claw-pole stator which surrounds the rotor as well as a claw-pole stator metal sheet is proposed, whereby a flux barrier for blocking stray magnetic fields of the claw-pole stator is provided in the area of a sensor for detecting rotor position. Interference to the sensor from the stray fields of the claw-pole stator can be prevented advantageously. The sensor is preferably a Hall sensor.

In a preferred embodiment, the flux barrier is provided in the area of a claw of the claw-pole stator. The area of the claw is acted upon less by magnetic flux.

The flux barrier is preferably arranged in the area of the sensor. As a result, the effect of a stray field on the sensor is further minimized.

In a preferred embodiment, the flux barrier is embodied as an air gap, in particular as a magnetic air gap. The applicable claws of the claw-pole stator cannot go into saturation so that the output of thereby induced faulty signals of the sensors is avoided. The air gap can be embodied in form of a narrow slot or have any other shape, such as, e.g., bore hole, free space and the like. The type and size of the air gap can influence the effectiveness of the flux barrier.

The air gap can be injected with plastic in a favorable embodiment. The risk of injury is diminished as a result.

### BRIEF DESCRIPTION OF THE DRAWINGS

Additional embodiments, aspects and advantages of the invention are also yielded independent of their summary in the claims, without restricting universality from the following on the basis of an exemplary embodiment of the invention depicted in the drawings.

In the following, the drawings show:

FIG. 1 A detailed view of a preferred electric machine with a claw-pole stator with a flux barrier

FIG. 2 A preferred claw-pole stator metal sheet with a flux barrier

### DETAILED DESCRIPTION

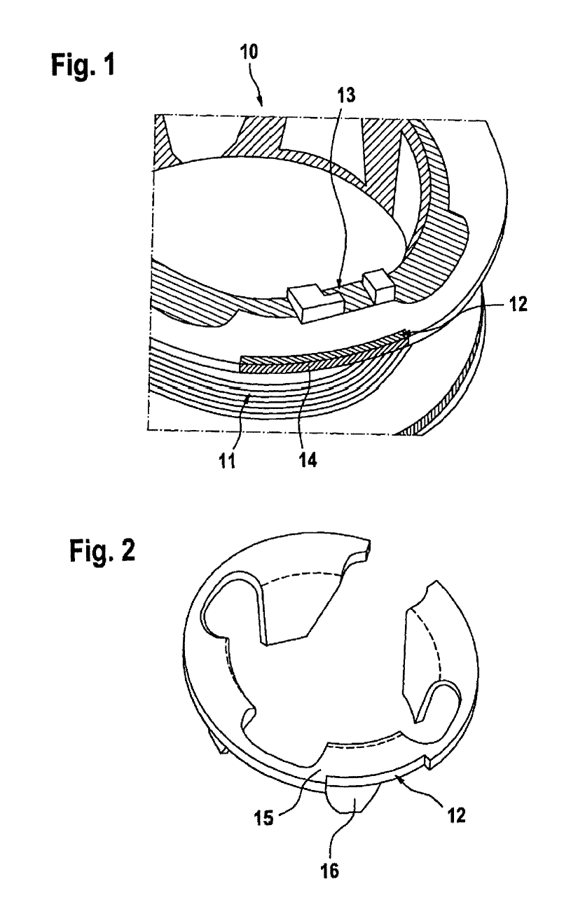

FIG. 1 shows a detailed section of an electric machine 10 with a rotor and a claw-pole stator 11 surrounding the rotor. The claw-pole stator 11 includes, among other things, a claw-pole stator metal sheet 15 as depicted in FIG. 2.

A flux barrier 12 for blocking stray fields of the claw-pole stator 11 is provided in the area of a sensor 13 (embodied as a Hall sensor) of a unit detecting rotor position. The claw-pole metal sheet 15 is embodied as an almost closed ring segment and features downward pointing claws 16 on its inner edge.

The flux barrier 12 is arranged in the area of a claw 16 of the claw-pole stator 11, which is adjacent to the sensor 13 in an installed state. A punch-out embodied as a narrow slot and forming the flux barrier 12 in the claw-pole stator 11 is arranged at the applicable claw 16 in the annular area of the claw-pole stator metal sheet 15.

The punch-out forms an air gap, which in a finished assembled claw-pole stator 11 is injected with plastic with a form fit. The size of the punch-out can influence the effectiveness of the flux barrier 12.

1. Electric machine comprising a rotor and a claw-pole stator (11) which surrounds the rotor, in which a unit detecting rotor position is provided, characterized in that a flux barrier (12) for blocking stray fields of the claw-pole stator (11) is provided in the area of a sensor (13) for detecting rotor position.

2. Electric machine according to claim 1, characterized in that the flux barrier (12) is provided in the area of a claw (15) of the claw-pole stator (11).

3. Electric machine according to claim 2, characterized in that the sensor (13) is arranged in the area of the flux barrier (12).

4. Electric machine according to claim 1, characterized in that the flux barrier (12) includes an air gap.

5. Electric machine according to claim 4, characterized in that the air gap is injected with plastic.

6. Claw-pole stator sheet metal for an electric machine (10) comprising a rotor and a claw-pole stator (11) surrounding the rotor, characterized in that a flux barrier (12) for blocking stray fields is arranged in an area in which the installation of a sensor (13) is provided for detecting rotor position.

7. Claw-pole stator sheet metal according to claim 6, characterized in that the flux barrier (12) includes a recess forming an air gap.

8. Claw-pole stator sheet metal according to claim 6, characterized in that the flux barrier (12) is located in the area of a claw (15).

9. Electric machine according to claim 3, characterized in that the flux barrier (12) includes a magnetic air gap.

10. Electric machine according to claim 9, characterized in that the air gap is injected with plastic.

11. Electric machine according to claim 4 wherein the air gap is a magnetic air gap.

12. Electric machine according to claim 7 wherein the air gap is a magnetic air gap.
